(19) United States
(12) Patent Application Publication
(10) Pub. No.: US 2018/0320581 A1
(43) Pub. Date: Nov. 8, 2018

(54) VARIABLE FLOW RATE VALVE MECHANISM AND TURBOCHARGER

(71) Applicant: IHI Corporation, Koto-ku (JP)

(72) Inventor: Jaemin HUH, Koto-ku (JP)

(73) Assignee: IHI Corporation, Koto-ku (JP)

(21) Appl. No.: 15/771,438

(22) PCT Filed: Oct. 24, 2016
(86) PCT No.: PCT/JP2016/081474

§ 371 Date: Apr. 27, 2018

(30) Foreign Application Priority Data
Oct. 29, 2015 (JP) 2015-212667

(51) Int. Cl. F02B 37/18; F16K 1/22; F16K 3/24; F16K 5/04; F02B 37/02

(52) U.S. Cl. CPC F02B 37/18; F16K 1/222; F16K 1/2268; F16K 5/0464; F02B 37/025; F16K 3/24

(57) ABSTRACT

A variable flow rate valve mechanism of the present disclosure includes a stem which is rotatably supported by a housing, a bearing which is inserted through a through-hole of the housing and supports the stem to be rotatable about an axis of the stem, and a valve portion which is provided at one end side of the stem and covers an opening. The stem is disposed so that the axis of the stem crosses the opening. The valve portion rotates about the axis of the stem and opens and closes an opening of a variable gas flow rate passage.

### TECHNICAL FIELD

The present disclosure relates to a variable flow rate valve mechanism and a turbocharger.

### BACKGROUND ART

Hitherto, a variable flow rate valve mechanism which adjusts a flow rate of a working fluid supplied to a turbine of a turbocharger is known (for example, see Patent Literature 1). The variable flow rate valve mechanism includes a bearing which is provided in a turbine housing accommodating a turbine, a rotation shaft which is rotatably supported by the bearing, and a valve body which is connected to one end side of the rotation shaft. The valve body is connected to the rotation shaft through a valve arm protruding in the radial direction of the rotation shaft. When the rotation shaft rotates about the axis, the valve arm swings and the valve body moves close to or away from the valve seat so as to adjust a flow rate of the working fluid.

### CITATION LIST

### Patent Literature

Patent Literature 1: Japanese Unexamined Patent Publication No. 2013-130133

### SUMMARY OF INVENTION

### Technical Problem

In the above-described related art, the valve body moves in a direction intersecting a seat surface of a valve seat to approach the valve seat when the valve is closed. For that reason, a sound is generated when the valve body collides with the valve seat.

The present disclosure describes a variable flow rate valve mechanism and a turbocharger capable of suppressing a sound generated when the valve is closed.

### Solution to Problem

The present disclosure provides a variable flow rate valve mechanism which opens and closes an opening of a variable gas flow rate passage, including: a stem which is rotatably supported by a housing; a bearing which is inserted into a through-hole of the housing and supports the stem to be rotatable about an axis of the stem; and a valve portion which is provided at one end side of the stem and covers the opening, in which the stem is disposed so that the axis of the stem crosses the opening, and the valve portion rotates about the axis of the stem and opens and closes the opening.

### Advantageous Effects of Invention

According to a variable flow rate valve mechanism of the present disclosure, it is possible to suppress a sound generated when a valve is closed.

### BRIEF DESCRIPTION OF DRAWINGS

FIG. 1 is a cross-sectional view illustrating a turbocharger according to a first embodiment of the present disclosure.

FIG. 2 is a side view illustrating a turbine housing of the turbocharger illustrated in FIG. 1.

FIG. 3 is a cross-sectional view taken along a line III-III of FIG. 2 and illustrates a state where a valve is closed.

FIG. 4 is a cross-sectional view taken along a line of FIG. 2 and illustrates a state where the valve is opened.

FIG. 5 is a perspective view illustrating a valve portion of a waste gate valve of the first embodiment.

FIG. 6A is a cross-sectional view illustrating a state where a valve is closed and FIG. 6B is a cross-sectional view illustrating a state where the valve is opened.

FIG. 7 is a cross-sectional view illustrating a state where the valve is closed.

FIG. 8 is a cross-sectional view illustrating a state where the valve is closed and is a cross-sectional view illustrating a modified example of a bypass passage.

FIG. 9 is a perspective view illustrating a valve portion of a waste gate valve of a second embodiment.

FIG. 10 is a cross-sectional view illustrating a state where the valve is closed.

FIG. 11 is a perspective view illustrating a valve portion of a waste gate valve of a third embodiment.

FIG. 12 is a cross-sectional view illustrating a state where the valve is closed and illustrates a cross-section taken along an axial direction of a stem.

FIG. 13A and FIG. 13B are cross-sectional views taken along a direction intersecting an axis of the stem, where FIG. 13A is a cross-sectional view illustrating a state where the valve is closed and FIG. 13B is a cross-sectional view illustrating a state where the valve is opened.

FIG. 14A and FIG. 14B are cross-sectional views taken along a direction intersecting an axis of a stem of a waste gate valve of a fourth embodiment, where FIG. 14A is a cross-sectional view illustrating a state where the valve is opened and FIG. 14B is a cross-sectional view illustrating a state where the valve is closed.

FIG. 15A and FIG. 15B are front views illustrating an opening of a bypass passage, where FIG. 15A is a diagram illustrating a circular opening and FIG. 15B is a diagram illustrating a rectangular opening.

FIG. 16 is a cross-sectional view taken along a direction intersecting an axis of a stem of a waste gate valve of a fifth embodiment and is a cross-sectional view illustrating a state where the valve is opened.

FIG. 17A is a side view illustrating a valve portion of the waste gate valve in FIG. 16 and FIG. 17B is a cross-sectional view taken along an axial direction.

FIG. 18A and FIG. 18B are diagrams illustrating a valve portion of a waste gate valve of a sixth embodiment, where FIG. 18A is a side view and FIG. 18B is a diagram when viewed from one end side in an axial direction.

### DESCRIPTION OF EMBODIMENTS

The present disclosure provides a variable flow rate valve mechanism which opens and closes an opening of a variable gas flow rate passage, including: a stem which is rotatably supported by a housing; a bearing which is inserted into a through-hole of the housing and supports the stem to be rotatable about an axis of the stein; and a valve portion which is provided at one end side of the stem and covers the opening, in which the stem is disposed so that the axis of the stem crosses the opening, and the valve portion rotates about the axis of the stem and opens and closes the opening.

The present disclosure provides a variable flow rate valve mechanism which opens and closes an opening of a variable gas flow rate passage, including: a stem which is rotatably supported by a housing; and a valve portion which is provided at one end side of the stem and covers the opening, in which the stem is disposed so that an axis of the stem crosses the opening, and the valve portion rotates about the axis of the stem and opens and closes the opening.

In the variable flow rate valve mechanism, since the axis of the stem is disposed cross the opening, the valve portion can be disposed at the front surface of the opening and the opening can be opened and closed by moving the valve portion in the circumferential direction of the stem in accordance with the rotation of the stem about the axis. That is, the opening can be closed by moving the valve portion in a direction along the seat surface without moving the valve portion with respect to the seat surface of the peripheral edge of the opening from a direction intersecting the seat surface. Accordingly, it is possible to reduce a sound generated when the valve portion contacts the seat surface of the peripheral edge of the opening. Additionally, the axis of the stem indicates the line passing through the axis center of the stem and includes the line extending toward the outside of the stem.

A wall surface having the opening may be provided with a curved support surface which is disposed at an opposite side to the bearing with the opening interposed therebetween in an axial direction of the stem and is curved in a circumferential direction of the stem, and the valve portion may include a valve portion peripheral surface which is disposed at one end side of the stem and slides on the curved support surface in a contact state. Accordingly, since one end side of the valve portion can be supported by the curved support surface and the other end side of the valve portion can be supported by the bearing in the axial direction of the stem, the valve portion is supported at both sides with the opening interposed therebetween. With such a both-end support structure, the deflection of the valve portion and the stem is suppressed and the rotation of the stem and the valve portion can be smoothly performed.

The valve portion may include a valve plate which is disposed along the axis of the stem and covers the opening. In this way, since the valve plate is provided, the valve portion can have a simple configuration and a light weight. When the valve portion has a plate shape, it is possible to ensure a flow rate by reducing a resistance with respect to a fluid in a state where the valve is opened.

A cross-section intersecting the axis of the stem in the valve portion may have a semi-circular shape. Accordingly, the opening can be covered by the peripheral surface of the valve portion having the semi-circular shape. Since the valve portion has the semi-circular shape, it is possible to form the valve portion only by processing one end side of the stem in a semi-circular shape.

A cross-section intersecting the axis of the stem in the valve portion may have a thin circular-arc shape. Accordingly, it is possible to form the valve portion only by processing one end side of the stem into a thin circular-arc shape. Further, the valve portion can have a simple configuration and a light weight. Since the valve portion has a thin thickness, it is possible to ensure a flow rate by reducing a resistance with respect to a fluid in a state where the valve is opened.

The valve portion may have a columnar shape and the valve portion may be provided with a penetration portion penetrating the valve portion in a radial direction of the stem. Accordingly, it is possible to form the valve portion only by processing the through-hole at one end side of the stem.

An outer peripheral surface of the valve portion may be flush with an outer peripheral surface of the stem. Accordingly, since it is possible to reduce a non-continuous shape at the connection portion between the valve portion and the stem, it is possible to prevent the concentration of stress. Further, it is possible to obtain a simple configuration.

The present disclosure relates to a turbocharger with the variable flow rate valve mechanism, including: a turbine; and a compressor which rotates by a rotational driving force generated by the turbine, in which the valve portion opens and closes an opening of the variable gas flow rate passage bypassing the turbine.

Since the turbocharger is disposed so that the axis of the stem crosses the opening in the variable flow rate valve mechanism, the valve portion can be disposed at the front surface of the opening and the opening can be opened and closed by moving the valve portion in the circumferential direction of the stem in accordance with the rotation of the stem about the axis. That is, the opening can be closed by moving the valve portion in a direction along the seat surface without moving the valve portion with respect to the seat surface of the peripheral edge of the opening from a direction intersecting the seat surface.

Accordingly, it is possible to reduce a sound generated when the valve portion contacts the seat surface of the peripheral edge of the opening.

### First Embodiment

Hereinafter, embodiments of the present disclosure will be described in detail with reference to the drawings. In addition, the same reference numerals will be given to the same or corresponding portions in the drawings and a repetitive description thereof will be omitted.

(Turbocharger)

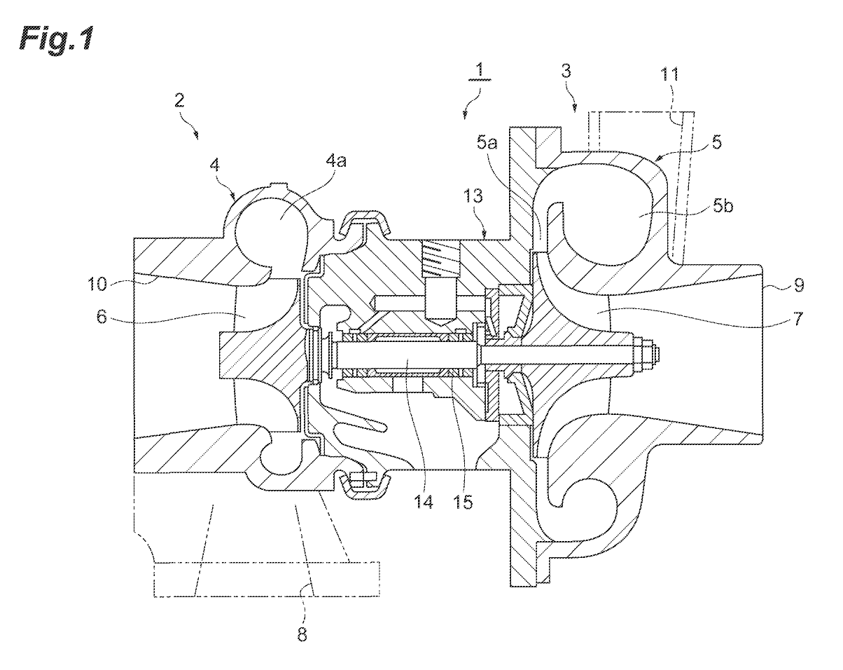

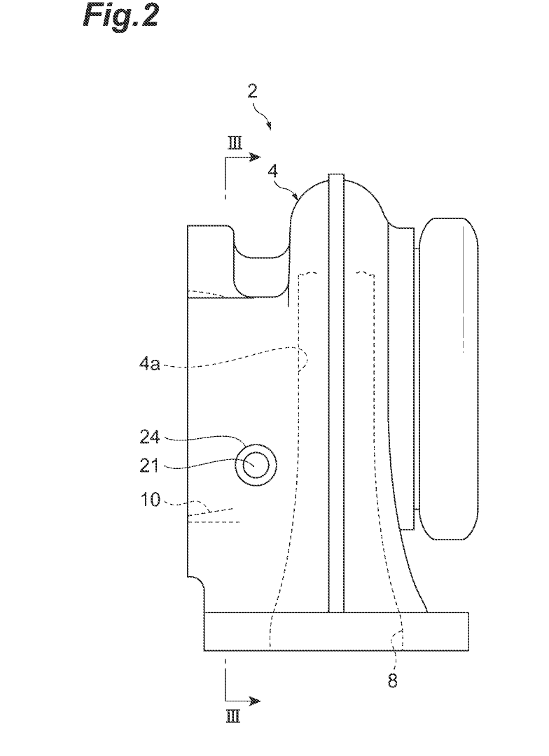

A turbocharger 1 illustrated in FIGS. 1 to 4 is a turbocharger for a vehicle and compresses air supplied to an engine (not illustrated) by using an exhaust gas discharged from the engine. The turbocharger 1 includes a turbine 2 and a compressor (a centrifugal compressor) 3. The turbine 2 includes a turbine housing 4 and a turbine impeller 6 accommodated in the turbine housing 4. The compressor 3 includes a compressor housing 5 and a compressor impeller 7 accommodated in the compressor housing 5.

The turbine impeller 6 is provided at one end of a rotation shaft 14 and the compressor impeller 7 is provided at the other end of the rotation shaft 14. A bearing housing 13 is provided between the turbine housing 4 and the compressor housing 5. The rotation shaft 14 is rotatably supported by the bearing housing 13 through a bearing 15.

The turbine housing 4 is provided with an exhaust gas inlet 8 and an exhaust gas outlet 10. An exhaust gas discharged from the engine flows into the turbine housing 4 through the exhaust gas inlet 8 to rotate the turbine impeller 6 and flows out of the turbine housing 4 through the exhaust gas outlet 10.

The compressor housing 5 is provided with a suction port 9 and a discharge port 11. When the turbine impeller 6 rotates as described above, the rotation shaft 14 and the compressor impeller 7 rotate. The rotating compressor impeller 7 sucks external air through the suction port 9, compresses the air, and discharges the air from the discharge port 11. The compressed air discharged from the discharge port 11 is supplied to the engine.

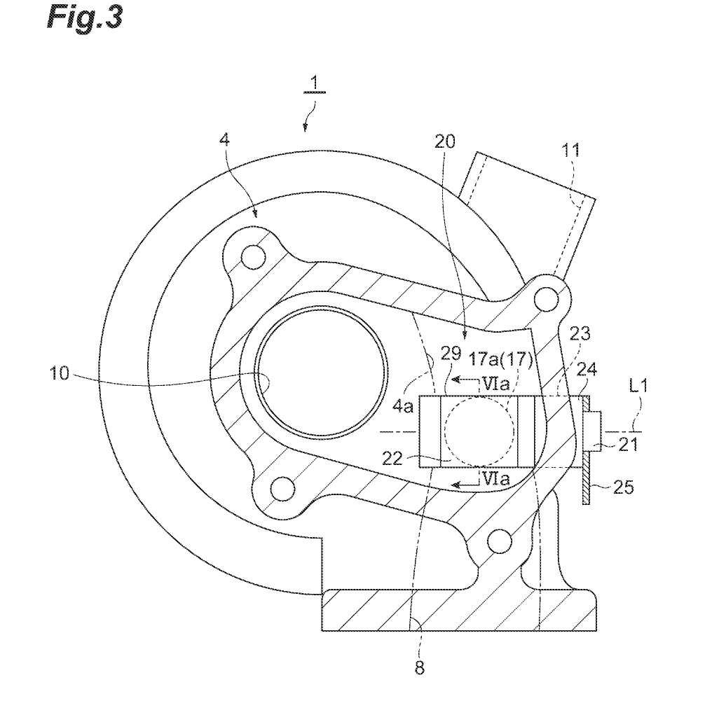

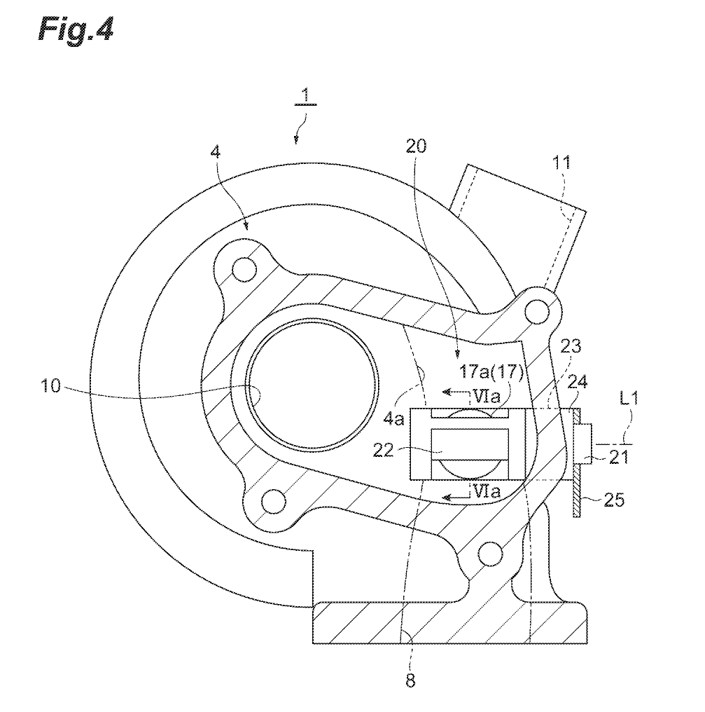

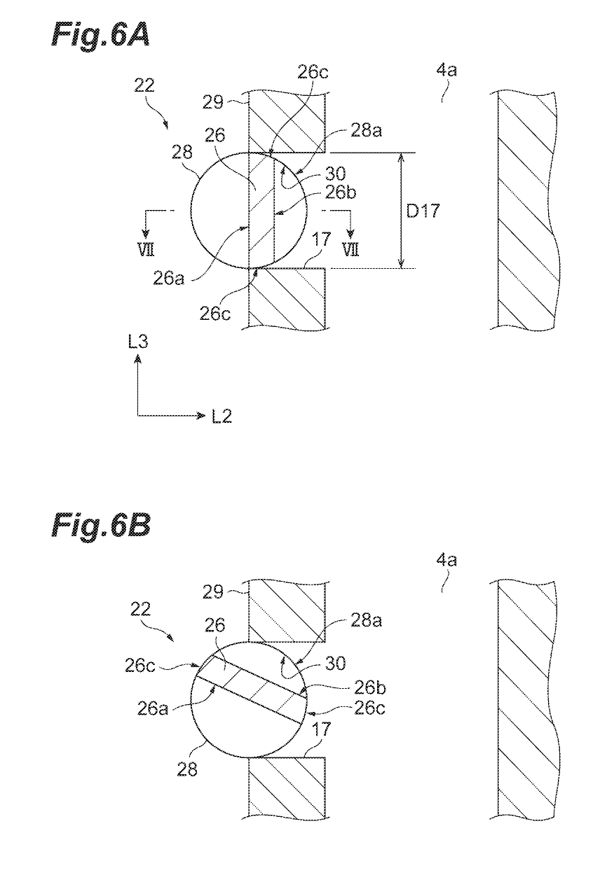

As illustrated in FIGS. 1 and 4, a bypass passage 17 (see FIG. 3, FIG. 4, FIG. 6A, and FIG. 6B) which derives a part of an exhaust gas introduced from the exhaust gas inlet 8 toward the exhaust gas outlet 10 while bypassing the turbine impeller 6 is formed inside the turbine housing 4. The bypass passage 17 is a variable gas flow rate passage which changes a flow rate of the exhaust gas supplied to the turbine impeller 6.

(Waste Gate Valve)

A waste gate valve 20 which serves as a variable flow rate valve mechanism is provided inside the turbine housing 4. The waste gate valve 20 is a valve which opens and closes an opening 17a of the bypass passage 17. The waste gate valve 20 includes a stem (a rotation shaft) 21 which is rotatably supported by the outer wall of the turbine housing 4 and a valve portion 22 which is provided at one end side of the stem 21 and covers the opening 17a.

The outer wall of the turbine housing 4 is provided with a support hole (a through-hole) 23 which penetrates the outer wall in the plate thickness direction of the outer wall. A cylindrical bushing (bearing) 24 is inserted into the support hole 23. The bushing 24 is fixed to the outer wall of the turbine housing 4 by press-inserting.

The stem 21 is inserted through the bushing 24 and is rotatably supported by the outer wall of the turbine housing 4. An axis L1 of the stem 21 is disposed to cross the opening 17a. The meaning of crossing the opening 17a indicates a state where the axis L1 is disposed at a position overlapping the opening 17a when viewed from a flow direction of a fluid passing through the opening 17a.

For example, a power transmission mechanism including a link member 25 or an operation rod is connected to a base end (the other end side end) disposed at the outside of the turbine housing 4 in the stem 21. The power transmission mechanism transmits a driving force generated by an actuator (not illustrated) serving as a driving source to the stem 21. Accordingly, the stem 21 is rotated about the axis L1 of the stem 21. As the actuator, a diaphragm actuator, an electric actuator, a hydraulic actuator (a hydraulic cylinder), and the like can be used.

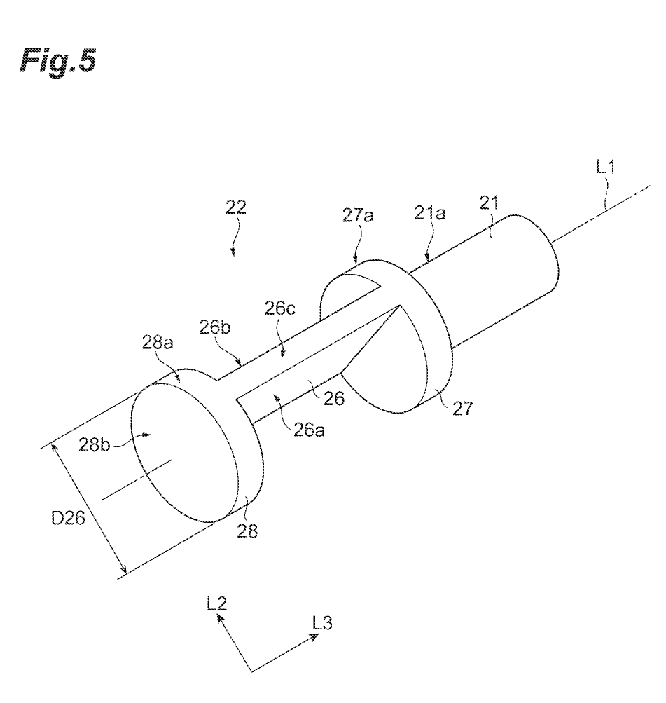

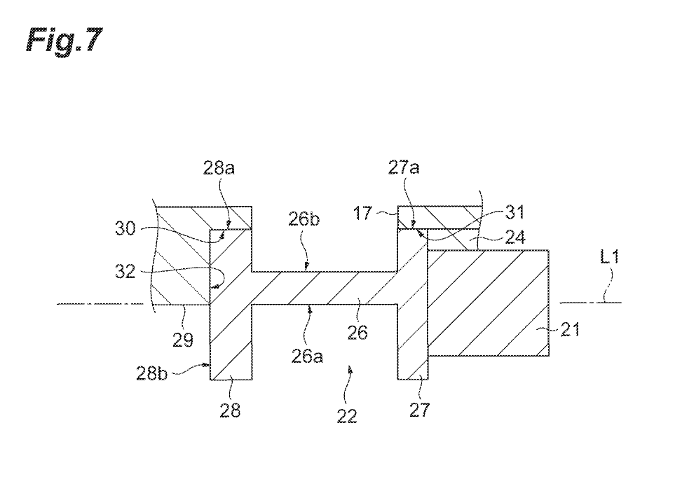

Next, the valve portion 22 which is provided at a front end side (one end side) of the stem 21 will be described. FIG. 5 is a perspective view illustrating the valve portion 22 of the waste gate valve 20 of the first embodiment. FIG. 6A is a cross-sectional view taken along a line VIa-VIa in FIG. 3 and illustrates a state where the valve is closed. FIG. 6B is a cross-sectional view taken along a line VIa-VIa in. FIG. 4. FIG. 7 is a cross-sectional view taken along a line in FIG. 6A and illustrates a state where the valve is closed.

The valve portion 22 includes a valve plate 26 which is disposed at a position covering the opening 17a of the bypass passage 17 and a pair of disk portions 27 and 28 which is disposed with the valve plate 26 interposed therebetween in the direction of the axis L1 of the stem 21.

The pair of disk portions 27 and 28 is disposed to face each other in the direction of the axis L1 of the stem 21 and the center lines of the disk portions 27 and 28 are disposed coaxially with the axis L1 of the stem 21. The disk portion 27 is disposed at the other end side in the direction of the axis L1 of the stem 21 and the disk portion 28 is disposed at one end side in the direction of the axis L1.

The outer diameters of the disk portions 27 and 28 are larger than, for example, the outer diameter of the stem 21′. Outer peripheral surfaces 27a and 28a of the disk portions 27 and 28 are sliding surfaces contacting curved surfaces 30 and 31 of a wall surface 29 illustrated in FIG. 6A, FIG. 6B, and FIG. 7. The wall surface 29 is a wall surface of a wall body separating a turbine scroll flow path 4a and the flow path on the side of the exhaust gas outlet 10 from each other.

Additionally, as illustrated in FIG. 5, FIG. 6A, and FIG. 6B, virtual lines which are orthogonal to the axis L1 of the stem 21 are indicated by L2 and L3. The lines L2 and L3 are orthogonal to each other.

The valve plate 26 is disposed in parallel to, for example, the axis L1 of the stem 21 and the thickness direction of the valve plate 26 is disposed along the line L2. A facing surface 26a in the thickness direction of the valve plate 26 is disposed on, for example, the axis L1 in parallel to the line L3. A facing surface 26b in the thickness direction of the valve plate 26 is disposed in parallel to the axis L1 and the line L3 at a deviated position in the extension direction of the line L2 from the axis U. A side surface 26c separated in the direction of the line L3 of the valve plate 26 becomes a curved surface flush with the outer peripheral surfaces 27a and 28a of the disk portions 27 and 28. The side surface 26c of the valve plate 26 is curved at the same curvature as those of the outer peripheral surfaces 27a and 28a of the disk portions 27 and 28.

Next, the arrangement of the valve portion 22 with respect to the opening 17a of the bypass passage 17 will be described. The opening 17a has a circular shape when viewed from the extension direction of the bypass passage 17. A diameter D26 of the valve portion 22 corresponds to a diameter D17 of the opening 17a. Specifically, the diameter D26 is slightly smaller than the diameter D17.

As illustrated in FIG. 6A, FIG. 6B, and FIG. 7, the wall surface 29 is provided with a concave portion which accommodates a part of the valve portion 22 in the radial direction of the valve portion 22. The concave portion is provided with the curved surfaces 30 and 31. The curved surfaces 30 and 31 are curved about the axis L1 of the stem 21. The curved surfaces 30 and 31 are disposed to be separated from each other in the direction of the axis L1 of the stem 21, the curved surface (the curved support surface) 30 contacts the outer peripheral surface (the valve portion peripheral surface) 28a of the disk portion 28, and the curved surface 31 contacts the outer peripheral surface 27a of the disk portion 27. The curved surfaces 30 and 31 are disposed at both sides with the opening 17a interposed therebetween in the direction of the axis L1. The curved surfaces 30 and 31 serve as seat surfaces contacting the valve portion 22.

As an example of the curved surfaces 30 and 31, the curvature radiuses of the curved surfaces 30 and 31 may be substantially the same as the curvature radius of the inner wall surface of the support hole 23 penetrating the outer wall of the turbine housing 4 or may be slightly smaller than the curvature radius of the inner wall surface of the support hole 23. The disk portions 28 and 27 which contact the curved surfaces 30 and 31 may be formed by a part of the side surface of the columnar stem 21. In this case, it is possible to easily process the support hole 23 along with the curved surfaces 30 and 31 by processing the support hole 23 using a predetermined tool such as an end mill from the outside (from the side of the link member 25 in FIG. 4) of the outer wall of the turbine housing 4 at the time of processing the support hole 23. Accordingly, it is possible to shorten a processing time. The curvature center of the support hole 23 can be highly precisely aligned to the curvature centers of the curved surfaces 30 and 31.

In the concave portion, an end surface 32 which intersects the axis L1 is for hied at one end side in the direction of the axis L1 of the stem 21. The end surface 32 is formed in a semi-circular shape when viewed from the direction of the axis L1. For example, the end surface 32 and the end surface 28b of the disk portion 28 may be disposed to face each other in a contact state.

Next, a state where the valve is opened or closed will be described. In the waste gate valve 20, the valve portion 22 rotates about the axis L1 when the stem 21 rotates about the axis L1. With this rotation, the valve plate 26 rotates about the axis U.

FIG. 3, FIG. 6A, and FIG. 7 illustrate a state where the waste gate valve 20 is closed. In the closed state, the valve plate 26 is disposed in substantially parallel to the wall surface 29 and the plate thickness direction of the valve plate 26 is disposed along the extension direction of the bypass passage 17. In the closed state, the side surfaces 26c and 26c of the valve plate 26 contact the upper and lower portions of the peripheral edge of the opening 17a. The outer peripheral surface 27a of the disk portion 27 contacts the curved surface 31 and the outer peripheral surface 28a of the disk portion 28 contacts the curved surface 30. With this configuration, the opening 17a is sealed in the entire circumference and the opening 17a is closed.

The sealed state herein means, for example, a state where a slight leakage occurs within a range in which the performance of the engine equipped with the turbocharger 1 is allowed. For example, a contact state between the outer peripheral surface 27a of the disk portion 27 and the curved surface 31 and a contact state between the outer peripheral surface 28a of the disk portion 28 and the curved surface 30 may be, for example, a plane contact or a linear contact. The bypass passage 17 does not need to be formed in a direction substantially orthogonal to the wall surface 29 and may be formed to be inclined with respect to the wall surface 29.

FIG. 4 and FIG. 6B illustrate a state where the waste gate valve 20 is opened. In the opened state, the valve plate 26 is disposed to be inclined with respect to the wall surface 29. An upper end side (the side surface 26c) of the valve plate 26 is separated from the bypass passage 17 and a lower end side (the side surface 26c) of the valve plate 26 enters the bypass passage 17. In this stale, a gap communicating with the bypass passage 17 is formed at the upper and lower sides of the valve plate 26 and an exhaust gas can flow through the gap.

Next, the operation and effect of the turbocharger 1 will be described.

An exhaust gas which flows from the exhaust gas inlet 8 passes through the turbine scroll flow path 4a and is supplied to the inlet of the turbine impeller 6. The turbine impeller 6 generates a rotational force by using a pressure of the exhaust gas supplied thereto and rotates the rotation shaft 14 and the compressor impeller 7 along with the turbine impeller 6. Accordingly, air sucked from the suction port 9 of the compressor 3 is compressed by using the compressor impeller 7. The air compressed by the compressor impeller 7 passes through a diffuser flow path 5a and a compressor scroll flow path 5b and is discharged from the discharge port 11. The air discharged from the discharge port 11 is supplied to the engine.

When a supercharging pressure (a pressure of air discharged from the discharge port 11) reaches a set pressure during the operation of the turbocharger 1, a driving force generated by the actuator is transmitted so that the stem 21 rotates about the axis L1 and the valve portion 22 rotates about the axis L1. Accordingly, the valve plate 26 is inclined with respect to the wall surface 29, a gap is formed between the valve plate 26 and the wall surface 29, and the waste gate valve 20 is opened. At this time, a part of the exhaust gas introduced from the exhaust gas inlet 8 passes through the bypass passage 17 and bypasses the turbine impeller 6. For that reason, a flow rate of the exhaust gas supplied to the turbine impeller 6 can be decreased.

Meanwhile, when the supercharging pressure becomes lower than the set pressure during the operation of the turbocharger 1, the stem 21 rotates about the axis L1 reversely (in the right rotation direction when viewed from the drawing sheet of FIG. 6A and FIG. 6B).

Specifically, the valve plate 26 is rotated to a position to be parallel to the wall surface 29. Accordingly, a gap between the valve plate 26 and the wall surface 29 is narrowed and the waste gate valve 20 is closed. That is, the bypassing of the exhaust gas using the bypass passage 17 is not performed in the turbine 2.

Since the axis L1 of the stem 21 is disposed to cross the opening 17a in the waste gate valve 20 of the turbocharger 1, the valve portion 22 is disposed at the front surface side of the opening 17a. Then, the stem 21 is rotated about the axis L1 and the valve portion 22 is rotated in the circumferential direction of the stem 21 to open and close the opening 17a. That is, the opening 17a can be closed by rotating the valve portion 22 in the direction along the curved surfaces 30 and 31 without moving the valve portion 22 with respect to the curved surfaces (the seat surfaces) 30 and 31 of the peripheral edge of the opening 17a from a direction intersecting the curved surfaces 30 and 31. As a result, it is possible to suppress a sound generated when the valve portion 22 contacts the seat surface of the peripheral edge of the opening 17a.

The wall surface 29 is provided with the curved surface (the curved support surface) 30 which is disposed at the opposite side to the bushing 24 with the opening 17a interposed therebetween in the direction of the axis L1 of the stem 21. The other end side of the valve portion 22 is connected to the stem 21 and is supported by the bushing 24 and one end side of the valve portion 22 is supported by the lower surface of the curved surface 30. The valve portion 22 is supported at both sides with the opening 17a interposed therebetween (in a both-end supported structure). Accordingly, the deflection of the valve portion 22 and the stein 21 is suppressed and the stem 21 and the valve portion 22 are smoothly rotated. For that reason, the abrasion of the outer peripheral surface of the stem 21 and the outer peripheral surfaces 27a and 28a of the disk portions 27 and 28 of the valve portion 22 is suppressed and the vibration of the waste gate valve 20 is suppressed.

The valve portion 22 includes the valve plate 26 which is disposed along the axis L1 of the stem 21 and covers the opening 17a. In this way, when the valve plate 26 is provided and a portion interposed between the disk portions 27 and 28 is formed in a plate shape, the valve portion 22 can have a simple configuration and a light weight.

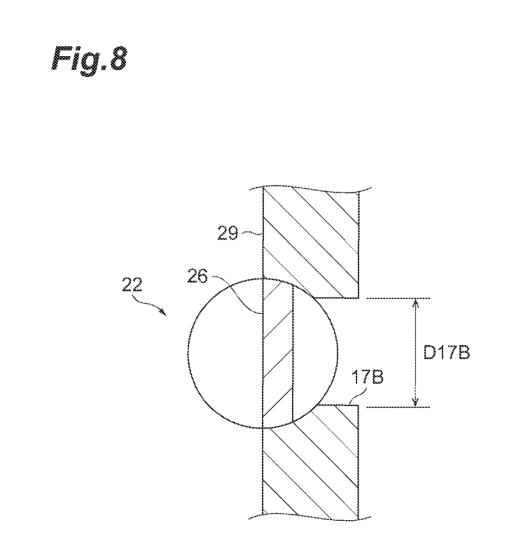

FIG. 8 is a cross-sectional view illustrating a state where the valve is closed and illustrates a modified example of a bypass passage 17B. As illustrated in FIG. 8, a diameter D17B of the bypass passage 17B may be smaller than the diameter D26 of the valve portion 22.

### Second Embodiment

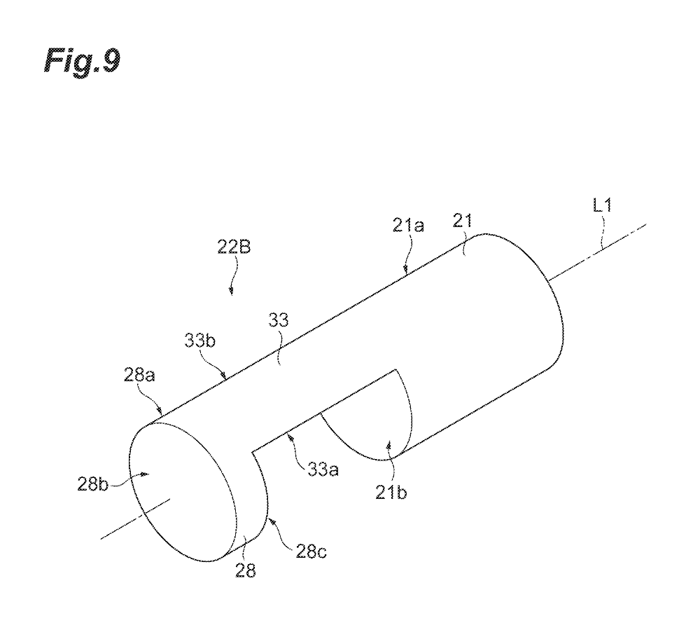

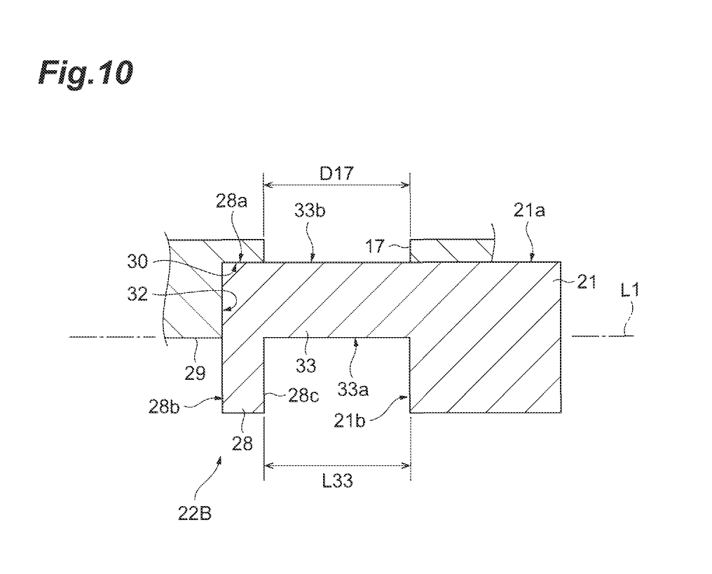

Next, a waste gate valve 20 according to a second embodiment will be described. FIG. 9 is a perspective view illustrating a valve portion 22B of the waste gate valve 20 of the second embodiment. FIG. 10 is a cross-sectional view illustrating a state where the valve is closed. The waste gate valve 20 of the second embodiment is different from the waste gate valve 20 of the first embodiment in that a half-circular portion 33 is provided instead of the valve plate 26 and an outer peripheral surface of a stem 21 is flush with an outer peripheral surface of the valve portion 22B as illustrated in FIGS. 9 and 10. Additionally, in the description of the second embodiment, the same description as that of the first embodiment will be omitted.

The valve portion 22B includes a half-circular portion 33 which is disposed at the other end side and a disk portion 28 which is disposed at one end side in the direction of the axis L1 of the stem 21. A cross-section of the half-circular portion 33 intersecting the axis L1 has a half-circular shape. In the direction of the axis L1, one end side of the half-circular portion 33 is connected to the disk portion 28 and the other end side of the half-circular portion 33 is connected to one end side of the stem 21.

A flat surface 33a of the half-circular portion 33 is formed along the axis L1. An outer peripheral surface 33b of the half-circular portion 33 is flush with an outer peripheral surface 21a of the stem 21 and an outer peripheral surface 28a of the disk portion 28 and has the same curvature. A length L33 of the half-circular portion 33 in the direction of the axis L1 corresponds to a diameter D17 of an opening 17a of a bypass passage 17. Additionally, the length L33 of the half-circular portion 33 along the axis L1 is a distance between an end surface 21b at one end side of the stem 21 and an end surface 28c at the other end side of the disk portion 28.

Also in the waste gate valve 20 of the second embodiment, the same operation and effect as those of the waste gate valve 20 of the first embodiment are obtained. In the valve portion 22B, the opening 17a is blocked by the outer peripheral surface 33b of the half-circular portion 33. Since the valve portion 22B includes the half-circular portion 33, it is possible to form the stem 21 and the valve portion 22B only by processing a one-end-side portion of a columnar member in a half-circular shape.

### Third Embodiment

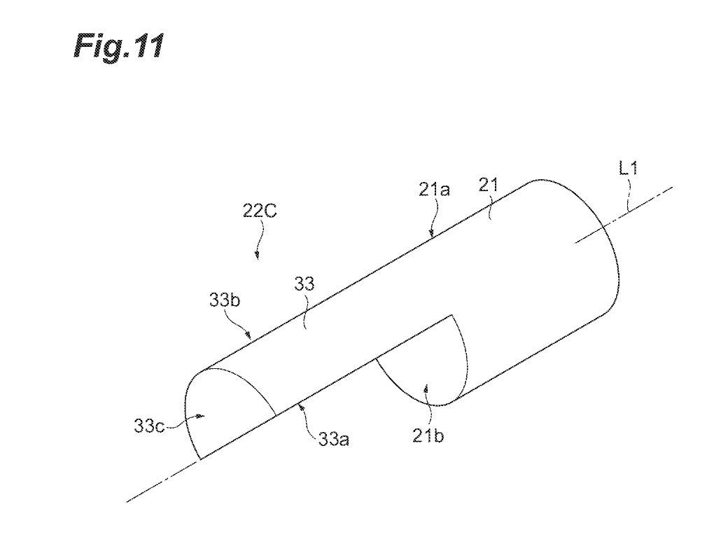

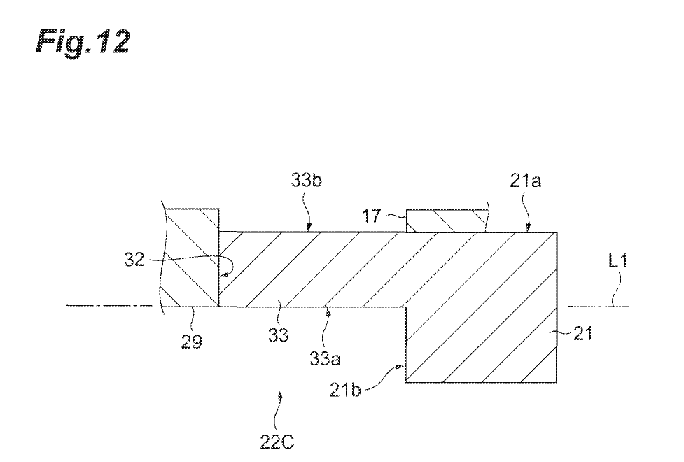

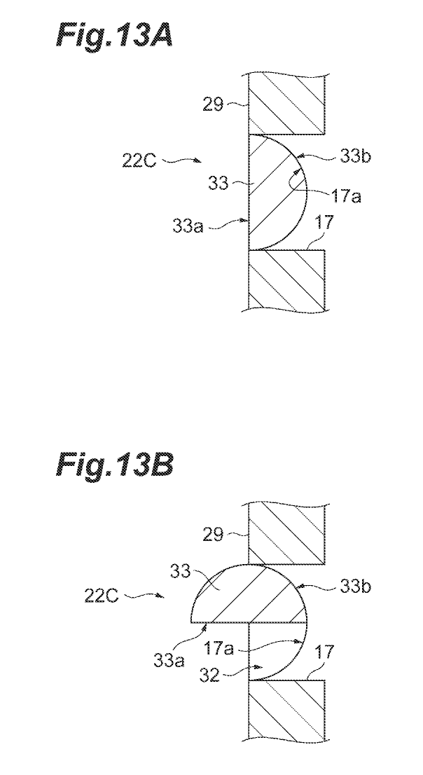

Next, a waste gate valve 20 according to a third embodiment will be described. FIG. 11 is a perspective view illustrating a valve portion 22C of the waste gate valve 20 of the third embodiment. FIG. 12 is a cross-sectional view illustrating a state where the valve is closed and illustrates a cross-section taken along the axis L1. FIG. 13A and FIG. 13B are cross-sectional views taken along a direction intersecting the axis L1. FIG. 13A is a cross-sectional view illustrating a state where the valve is closed and FIG. 13B illustrates a state where the valve is opened. The waste gate valve 20 of the third embodiment is different from the waste gate valve 20 of the second embodiment in that a disk portion 28 is not formed at one end side of a half-circular portion 33 as illustrated in FIG. 11 to FIGS. 13A and 13B. Additionally, in the description of the third embodiment, the same description as those of the first and second embodiments will be omitted.

As illustrated in FIG. 12, one-end-side end surface 33c of the half-circular portion 33 of the valve portion 22c is disposed to face an end surface 32 in the direction of the axis L1. Also in the waste gate valve 20, the stem 21 and the valve portion 22c rotate about the axis L1 so that an opening 17a is opened and closed and a flow rate of an exhaust gas supplied to a turbine 2 is adjusted.

### Fourth Embodiment

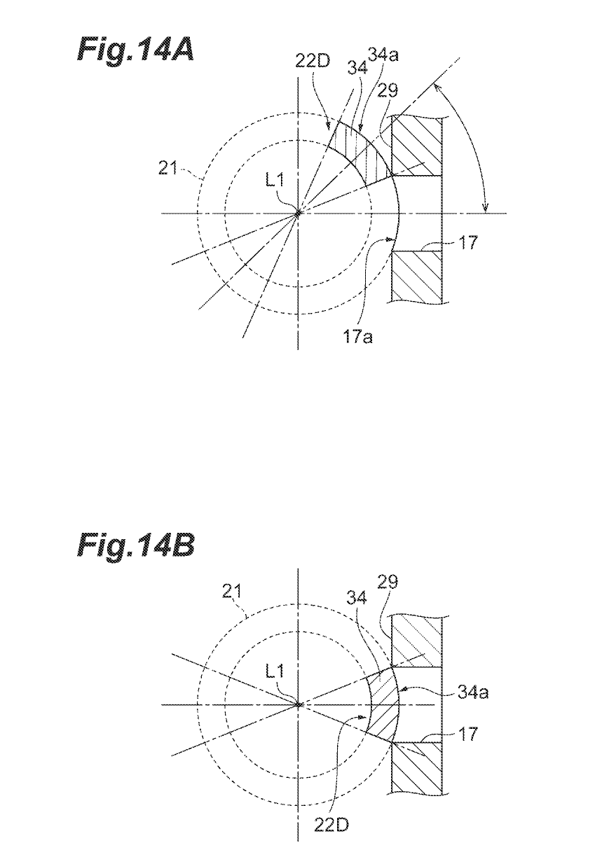

Next, a waste gate valve 20 according to a fourth embodiment will be described. FIG. 14A and FIG. 14B are cross-sectional views taken along a direction intersecting an axis L1 of the waste gate valve 20 of the fourth embodiment. FIG. 14A illustrates a state where the valve is opened and FIG. 14B illustrates a state where the valve is closed. The waste gate valve 20 of the fourth embodiment is different from the waste gate valve 20 of the third embodiment in that a thin circular-arc portion 34 is provided instead of the half-circular portion 33 as illustrated in FIG. 14A and FIG. 14B. Additionally, in the description of the fourth embodiment, the same description as those of the first to third embodiments will be omitted.

A valve portion 22D of the waste gate valve 20 of the fourth embodiment includes the thin circular-arc portion 34 which is continuous in the direction of the axis L1 of a stem 21. The thin circular-arc portion 34 has a curved plate shape in a cross-section intersecting the axis L1 and is curved along an outer peripheral surface 21a of the stem 21. An outer peripheral surface 34a of the thin circular-arc portion 34 is flush with the outer peripheral surface 21a of the stem 21 and has the same curvature as the outer peripheral surface 21a of the stem 21. An arc length of the circular-arc outer peripheral surface 34a of the thin circular-arc portion 34 corresponds to the diameter of the opening 17a of the bypass passage 17.

In the valve portion 22D, the opening 17a is blocked by the outer peripheral surface 34a of the thin circular-arc portion 34. Also in the waste gate valve 20, the thin circular-arc portion 34 of the valve portion 22D moves in the circumferential direction of the stem 21 when the stem 21 rotates about the axis L1. As illustrated in FIG. 14B, the thin circular-arc portion 34 is disposed to block the opening 17a so that the valve is closed. As illustrated in FIG. 14A, the thin circular-arc portion 34 moves upward from the opening 17a and is disposed at a position deviated from the opening 17a so that the valve is opened.

Since the valve portion 22D includes the thin circular-arc portion 34, the valve portion 22D is formed only by processing a one-end-side portion of the columnar member in a circular-arc shape.

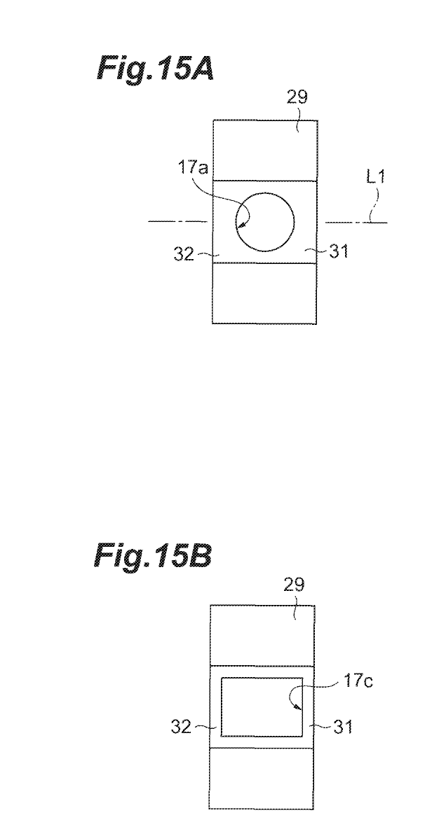

FIG. 15A and FIG. 15B are front views illustrating an opening of the bypass passage 17. FIG. 15A is a diagram illustrating a circular opening and FIG. 15B is a diagram illustrating a rectangular opening. As illustrated in FIG. 15A and FIG. 15B, the opening 17a is disposed at the concave portion of the wall surface 29. Curved surfaces 30 and 31 are formed at the peripheral edge of the opening 17a in the concave portion. The curved surfaces 30 and 31 contact the outer peripheral surface 34a of the thin circular-arc portion 34. Additionally, the shape of the opening is not limited to a circular shape. As illustrated in FIG. 15B, a rectangular shape or other shapes may be employed.

### Fifth Embodiment

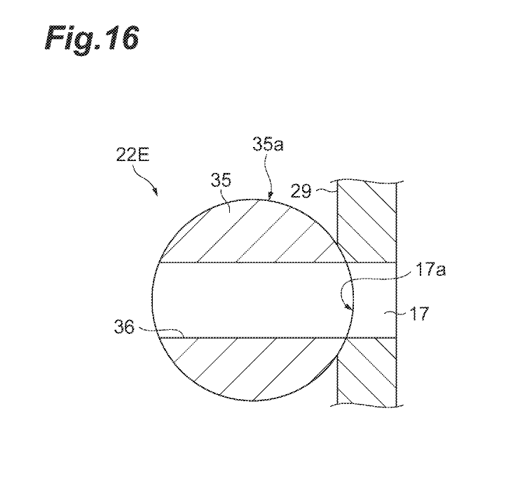

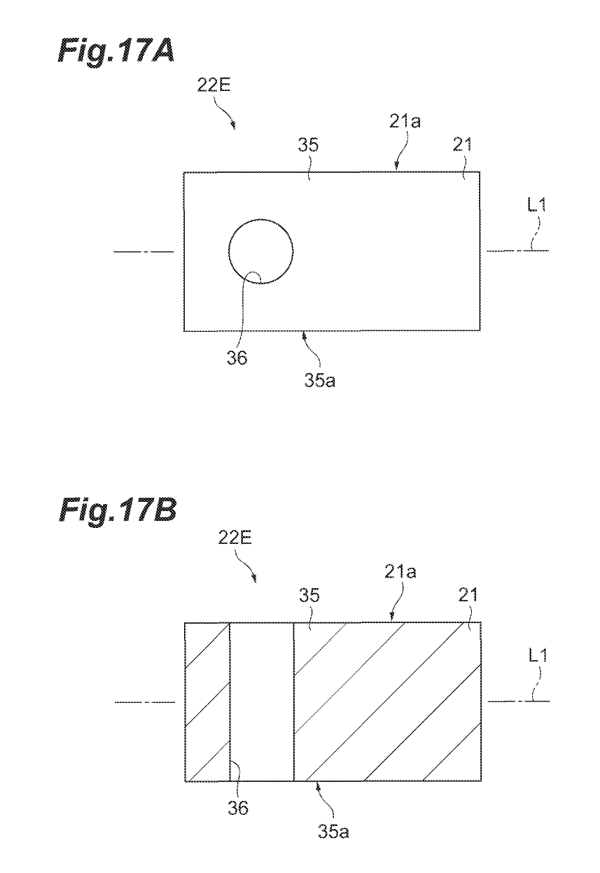

Next, a waste gate valve 20 according to a fifth embodiment will be described. FIG. 16 is a cross-sectional view taken along a direction intersecting an axis L1 of the waste gate valve of the fifth embodiment and is a cross-sectional view illustrating a state where the valve is opened. FIG. 17A is a side view illustrating a valve portion of the waste gate valve of FIG. 16 and FIG. 17B is a cross-sectional view taken along an axial direction. The waste gate valve 20 according to the fifth embodiment is different from the waste gate valve 20 according to the third embodiment in that a column portion 35 provided with a through-hole 36 is provided instead of the half-circular portion 33 as illustrated in FIG. 16, FIG. 17A, and FIG. 17B. Additionally, in the description of the fifth embodiment, the same description as those of the first to fourth embodiments will be omitted.

A valve portion 22E of the waste gate valve 20 of the fifth embodiment includes the column portion 35 which is continuous in the direction of the axis L1 of the stem 21. The axis of the column portion 35 is disposed coaxially with the axis L1 of the stem 21. An outer peripheral surface 35a of the column portion 35 is flush with an outer peripheral surface 21a of the stem 21. The curvature of the outer peripheral surface 35a of the column portion 35 is the same as the curvature of the outer peripheral surface 21a of the stem 21. The outer diameters of the column portion 35 and the stem 21 are larger than the inner diameter of an opening 17a of a bypass passage 17.

The through-hole 36 of the column portion 35 penetrates the column portion 35 in the radial direction. The inner diameter of the through-hole 36 corresponds to the inner diameter of the opening 17a of the bypass passage 17.

Also in the waste gate valve 20 of the fifth embodiment, the column portion 35 of the valve portion 22E rotates when the stem 21 rotates about the axis L1. As illustrated in FIG. 16, the through-hole 36 is disposed to match the opening 17a of the bypass passage 17 so that the valve is opened. When the column portion 35 rotates from this state so that the outer peripheral surface 35a of the column portion 35 blocks the opening 17a, the valve is closed.

### Sixth Embodiment

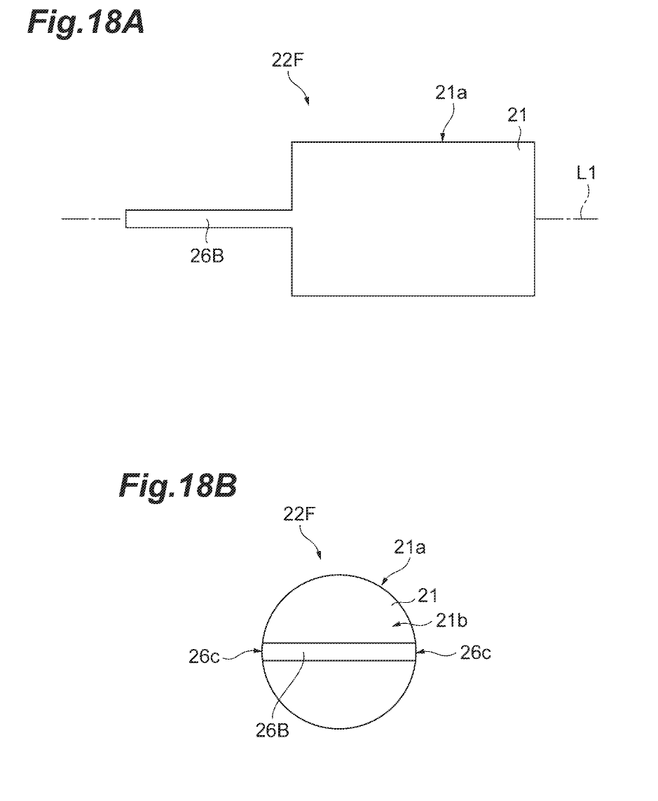

Next, a waste gate valve 20 according to a sixth embodiment will be described. FIG. 18A and FIG. 18B are diagrams illustrating a valve portion of the waste gate valve 20 of the sixth embodiment, FIG. 18A is a side view when viewed from a direction intersecting an axis L1, and FIG. 18B is a diagram when viewed from one end side in the direction of the axis L1. The waste gate valve 20 of the sixth embodiment is different from the waste gate valve 20 of the first embodiment in that the arrangement of a valve plate 26B in the radial direction is different, a side surface 26c of the valve plate 26B is flush with an outer peripheral surface 21a of a stem 21, and a disk portion 28 is not provided as illustrated in FIG. 18A and FIG. 18B. Additionally, in the description of the sixth embodiment, the same description as those of the first to fifth embodiments will be omitted.

A valve portion 22F includes a valve plate 26B which protrudes from an end surface 21b of the stem 21 in the direction of the axis L1. The valve plate 26B is disposed along the axis L1 and is disposed at a position where the axis L1 passes in the radial direction. The length of the valve plate 26B (the length along the axis L1) and the width (the length in the direction intersecting the axis L1) are larger than the diameter of the opening 17a.

A one-end-side end surface of the valve plate 26B in the direction of the axis L1 is a surface which can contact the facing end surface 32 (see FIG. 7) in the direction of the axis L1.

Also in the waste gate valve 20 of the sixth embodiment, when the stem 21 rotates about the axis L1 so that the valve plate 26B of the valve portion 22F rotates and the valve plate 26B is disposed at a position covering the opening 17a, the valve is closed. The valve plate 26B is disposed to be inclined with respect to the wall surface 29 (see FIG. 6A and FIG. 6B) so that the valve is opened. Additionally, in a state where the valve is opened, the valve plate 26B may be in parallel to the flow of the bypass passage 17. In this case, the flow rate at the opening 17a can be increased.

As a modified example of the valve plate 26B, the valve plate may protrude outward in relation to the outer peripheral surface 21a of the stem 21 in the radial direction of the stem 21.

The present disclosure is not limited to the above-described embodiments and can be modified into various forms as below without departing from the spirit of the present disclosure.

In the above-described embodiments, the valve portion is formed to include the valve plate, the half-circular portion, the thin circular-arc portion, or the column portion, but the valve portion may have other shapes. For example, a valve portion having a triangular or rectangular cross-sectional shape may be used. Briefly, the valve portion may be disposed inside the opening 17a or near the opening 17a to adjust the flow rate of the fluid passing through the opening 17a.

In the first embodiment, for example, the outer diameters of the disk portions 27 and 28 are larger than the outer diameter of the stem 21, but the outer diameters of the disk portions 27 and 28 may be equal or smaller than the outer diameter of the stem 21. For example, the inner diameter and the outer diameter of the bushing 24 may be appropriately set so that the valve portion 22 can be inserted thereinto after the bushing 24 is fixed to the support hole 23 of the outer wall of the turbine housing 4 by press-inserting. In this case, since it is easy to handle an operation of press-inserting the bushing 24 into the support hole 23 of the outer wall of the turbine housing 4, the assembly time can be shortened.

In the above-described embodiments, the end surface 32 disposed at the concave portion of the wall surface 29 and forming the concave portion is provided, but the end surface 32 may not be provided. In this case, for example, a configuration may be employed in which the end surface 28b of the disk portion 28 does not contact the end surface of the concave portion in the direction of the axis L1 of the stem 21 and the bushing 24 and the link member 25 are disposed to contact each other. For example, the wall surface 29 may be provided with a groove which extends toward the exhaust gas outlet 10 (see FIG. 3) in relation to the end surface 28b of the disk portion 28. In this case, the valve portion 22 can be assembled in such a manner that the valve portion 22 is moved from the inside of the outer wall of the turbine housing 4 (the opposite side to the link member 25, the exhaust gas outlet 10) at the time of assembling the valve portion 22. For example, since the valve portion 22 can be assembled from a direction opposite to the direction of assembling the bushing 24, the assembly can be easily performed regardless of the size relationship between the outer diameters of the disk portions 27 and 28 and the outer diameter of the stem 21.

In the above-described embodiments, a configuration including the bushing 24 has been described, but the bushing 24 may not be provided. In this case, the stem 21 is directly supported by the support hole 23 formed at the outer wall of the turbine housing 4.

The waste gate valve may be provided with a positioning structure for defining a reference point (a zero point) of a rotation position of the valve portion. For example, the reference point of the rotation position of the valve portion may be set when a protrusion portion contacting the link member 25 is provided so that the link member 25 contacts the protrusion portion.

In the above-described embodiment, an example has been described in which the turbocharger 1 employing the waste gate valve 20 is applied to a vehicle, but the application of the turbocharger is not limited to the vehicle. For example, the turbocharger may be applied to a vehicle engine and other engines.

### INDUSTRIAL APPLICABILITY

According to the variable flow rate valve mechanism and the turbocharger of the present disclosure, it is possible to suppress the generation of a sound when a valve is closed.

### REFERENCE SIGNS LIST

1 turbocharger
4 turbine housing (housing)
17 bypass passage (variable gas flow rate passage)
17a opening
20 waste gate valve (variable flow rate valve mechanism)
21 stem
21a outer peripheral surface
22, 22B, 22C, 22D, 22E, 22F valve portion
23 support hole (through-hole)
24 bushing (bearing)
26, 26B valve plate
28 disk portion
28a outer peripheral surface (valve portion peripheral surface)
29 wall surface (wall surface provided with opening)
30 curved surface (curved support surface)
33 half-circular portion
34 thin circular-arc portion
35 column portion
36 through-hole (penetration portion)
L1 axis of stem

1. (canceled)

2. A variable flow rate valve mechanism which opens and closes an opening of a variable gas flow rate passage, comprising:
a stem which is rotatably supported by a housing;
a bearing which is inserted into a through-hole of the housing and supports the stem to be rotatable about an axis of the stem; and
a valve portion which is provided at one end side of the stem and covers the opening, wherein
the stem is disposed so that the axis of the stem crosses the opening,
a wall surface having the opening is provided with a curved support surface which is disposed at an opposite side to the bearing with the opening interposed therebetween in an axial direction of the stem and is curved in a circumferential direction of the stem,
the valve portion includes a valve portion peripheral surface which is disposed at one end side of the stem and slides on the curved support surface in a contact state, and
the valve portion rotates about the axis of the stem and opens and closes the opening.

3. The variable flow rate valve mechanism according to claim 2,
wherein the valve portion includes a valve plate which is disposed along the axis of the stem and covers the opening.

4. The variable flow rate valve mechanism according to claim 2,
wherein a cross-section intersecting the axis of the stem in the valve portion has a semi-circular shape.

5. The variable flow rate valve mechanism according to claim 2,
wherein a cross-section intersecting the axis of the stem in the valve portion has a thin circular-arc shape.

6. The variable flow rate valve mechanism according to claim 2,
wherein the valve portion has a columnar shape, and
the valve portion is provided with a penetration portion penetrating the valve portion in a radial direction of the stem.

7. The variable flow rate valve mechanism according to claim 2,
wherein an outer peripheral surface of the valve portion is flush with an outer peripheral surface of the stem.

8. A variable flow rate valve mechanism which opens and closes an opening of a variable gas flow rate passage, comprising:
a stem which is rotatably supported by a housing; and
a valve portion which is provided at one end side of the stem and covers the opening, wherein
the stem is disposed so that an axis of the stem crosses the opening,
a wall surface having the opening is provided with a curved support surface which is disposed at an opposite side to the bearing with the opening interposed therebetween in an axial direction of the stem and is curved in a circumferential direction of the stem,
the valve portion includes a valve portion peripheral surface which is disposed at one end side of the stem and slides on the curved support surface in a contact state, and
the valve portion rotates about the axis of the stem and opens and closes the opening.

9. A turbocharger with the variable flow rate valve mechanism according to claim 2, comprising:
a turbine; and
a compressor which rotates by a rotational driving force generated by the turbine,
wherein the valve portion opens and closes an opening of the variable gas flow rate passage bypassing the turbine.

10. A turbocharger with the variable flow rate valve mechanism according to claim 8, comprising:
a turbine; and
a compressor which rotates by a rotational driving force generated by the turbine,
wherein the valve portion opens and closes an opening of the variable gas flow rate passage bypassing the turbine.
